(19) United States
(12) Patent Application Publication
(10) Pub. No.: US 2016/0084715 A1
(43) Pub. Date: Mar. 24, 2016

(54) OPTICAL FREQUENCY CALIBRATION METHOD

(71) Applicant: CANON KABUSHIKI KAISHA, Tokyo (JP)

(72) Inventor: Yuichiro Hori, Kawasaki-shi (JP)

(21) Appl. No.: 14/786,008

(22) PCT Filed: Apr. 18, 2014
(86) PCT No.: PCT/JP2014/061805

§ 371 Date: Oct. 21, 2015

(30) Foreign Application Priority Data
Apr. 25, 2013 (JP) 2013-092112

(51) Int. Cl. G01J 9/02

(52) U.S. Cl. CPC G01J 9/0246

(57) ABSTRACT

A method of calibrating an optical frequency of light emitted from a wavelength-swept light source thereby allowing it to compensate for an error of a wavelength includes performing a first process of measuring an optical frequency range of the emitted light while changing a control parameter associated with an optical frequency sweeping mechanism and determining a correspondence between the control parameter and the optical frequency range, performing a second process of measuring a maximum of a gain of an active medium included in the wavelength-swept light source and determining a correspondence between the maximum of the gain and the control parameter, performing a third process of determining a relationship between the optical frequency range of the emitted light and the control parameter corresponding to the maximum gain of the active medium, and performing a fourth process of adjusting the control parameter based on the determined relationship.

### TECHNICAL FIELD

The present invention relates to a method of calibrating an optical frequency of a wavelength-swept light source, a program therefor, and a storage medium therefor. The present invention also relates to an optical frequency calibration apparatus and an optical coherence tomography apparatus.

### BACKGROUND ART

In recent years, an optical coherence tomography (OCT) apparatus has been intensively researched and developed in various fields including medical applications. The OCT has several types. In a type called swept source-OCT (SS-OCT), a wavelength-swept light source is used to provide light whose wavelength is continuously changed over a certain range. This type of OCT has advantages over other types in operation speed, signal-to-noise ratio, etc., and thus it is expected as a promising next-generation OCT apparatus.

As for a wavelength-swept light source for use in SS-OCT apparatuses, many types are known. An example is a Fourier domain mode locking (FDML) laser which has a cavity including a gain medium and a wavelength-swept filter thereby allowing it to sweep the wavelength and which may further have a dispersion compensation mechanism. In an another example, a mirror of an external cavity laser or a vertical cavity surface emitting laser (VCSEL) is realized in the form of a micro electronic mechanical system (MEMS) such that the mirror is movable to change the cavity length thereby allowing it to sweep the wavelength. A still another example is a sampled-grating (SG) distributed Bragg reflector (DBR) laser in which a cavity is formed using a modulation DBR and such that a refractive index thereof is electrically or thermally variable thereby allowing it to adjust the cavity oscillation wavelength.

In an OCT apparatus using such a wavelength-swept light source, a wavenumber acquisition interferometer is often used to compensate for nonlinearity between a wavenumber (frequency) of swept light and time such that it becomes possible to obtain data at equal intervals of wavenumber. Examples of wavenumber acquisition interferometers for this purpose include a general-type Michelson interferometer, a Mach-Zehnder interferometer, a Fabry-Perot interferometer, etc. Part of light emitted from the light source is extracted and is passed through the interferometer described above to obtain a reference signal with equal intervals of wavenumber. By using the resultant signal as a reference signal for operation of an analog-to-digital (A/D) converter, it is possible to extract only data with the equal intervals of wavenumber from optical signal data. PTL 1 discloses an SS-OCT apparatus including a wavelength-swept laser serving as a light source and also including a wavenumber acquisition interferometer such as that described above.

### CITATION LIST

### Patent Literature

PTL 1 Japanese Patent Laid-Open No. 2007-24677

### SUMMARY OF INVENTION

### Technical Problem

However, the conventional wavelength-swept light sources described above have a problem that a range of wavelength (frequency) of emitted light may have an initial error of the wavelength sweeping range of a wavelength sweeping mechanism or may have a change in the wavelength sweeping range with time, and a change may occur in a positional relationship between a gain and the range of wavelength. To handle the above situation, it may be necessary to compensate for an initial error of the wavelength sweeping range or a change in the wavelength sweeping range occurring with time. A mechanism for calibrating a frequency of light emitted from the wavelength-swept light source may be provided in the OCT apparatus, which may make it possible to automatically calibrate the apparatus. In particular, it may be advantageous to configure the OCT apparatus such that the calibration is possible using only internal parts of the OCT apparatus.

In view of the above, the present invention is directed to an optical frequency calibration method for a wavelength-swept light source, capable of calibrating an optical frequency of the wavelength-swept light source to compensate for an initial error of the wavelength sweeping range or a change in the wavelength sweeping range occurring with time, and a program and a storage medium therefor. The present invention is also directed to an optical frequency calibration apparatus and an OCT apparatus.

### Advantageous Effects of Invention

By using at least one of the optical frequency calibration method for the wavelength-swept light source, the program, the storage medium, the optical frequency calibration apparatus, and the OCT apparatus according to embodiments of the invention, it becomes possible to calibrate an optical frequency of the wavelength-swept light source to compensate for an initial error of the wavelength sweeping range or a change in the wavelength sweeping range occurring with time.

### Solution to Problem

In an aspect, the present invention provides a method of calibrating an optical frequency of light emitted from a wavelength-swept light source based on information acquired from a wavenumber acquisition interferometer thereby allowing it to compensate for an error of the wavelength sweeping range of the wavelength-swept light source, the method including performing a first process of measuring an optical frequency range of the emitted light by the wavenumber acquisition interferometer while changing a control parameter associated with an optical frequency sweeping mechanism included in the wavelength-swept light source, and determining a correspondence between the control parameter and the optical frequency range, performing a second process of measuring a maximum of a gain of an active medium included in the wavelength-swept light source and determining a correspondence between the maximum of the gain and the control parameter, performing a third process of determining a relationship between the optical frequency range of the emitted light and the control parameter corresponding to the maximum of the gain of the active medium, and performing a fourth process of adjusting the control parameter based on a result of the determination as to the relationship.

In an aspect, the present invention provides a program configured to control a computer to execute the method of calibrating the optical frequency.

In an aspect, the present invention provides a computer-readable storage medium storing the program.

In an aspect, the present invention provides an apparatus including a wavenumber acquisition interferometer and a frequency sweep calibration unit and configured to calibrate an optical frequency of light emitted from a wavelength-swept light source based on information acquired from the wavenumber acquisition interferometer thereby allowing it to compensate for an error of the wavelength sweeping range of the wavelength-swept light source, the frequency sweep calibration unit including an optical frequency range determination unit configured to measure an optical frequency range of the light emitted from the wavenumber acquisition interferometer and determine a correspondence between a control parameter of an optical frequency sweeping mechanism included in the wavelength-swept light source and the optical frequency range, a maximum-of-gain determination unit configured to determine a correspondence between a maximum of a gain of an active medium included in the wavelength-swept light source and a value of the control parameter, and an adjustment unit configured to determine a relationship between values of the control parameter corresponding to the optical frequency range and a value of the control parameter corresponding to the maximum gain, evaluate a deviation of a value from a proper value of the control parameter, and adjust the values of the control parameter based on the evaluated deviation.

In an aspect, the present invention provides an optical coherence tomography apparatus configured to perform a tomographic measurement on a subject by performing, using an operational processing unit, an operational process on combined light obtained by combining light returned from the subject illuminated with measurement light and reference light corresponding to the measurement light, wherein the wavenumber acquisition interferometer in the optical frequency calibration apparatus is disposed in the optical coherence tomography apparatus.

In an aspect, the present invention provides an optical coherence tomography apparatus configured to perform a tomographic measurement on a subject by performing, using an operational processing unit, an operational process on combined light obtained by combining light returned from the subject illuminated with measurement light and reference light corresponding to the measurement light, wherein the frequency sweep calibration unit in the optical frequency calibration apparatus is disposed in the operational processing unit.

Further features of the present invention will become apparent from the following description of exemplary embodiments with reference to the attached drawings.

### BRIEF DESCRIPTION OF DRAWINGS

FIG. 1 is a diagram illustrating a system of an optical coherence tomography apparatus according to a first embodiment.

FIG. 2 is a diagram illustrating a procedure of calibrating a frequency of light emitted from a wavelength-swept light source according to the first embodiment.

FIG. 3 is a conceptual diagram illustrating data output from a wavenumber acquisition interferometer according to the first embodiment.

FIG. 4 is a conceptual diagram illustrating a relationship of an active layer gain of a light source and a frequency sweeping range and a frequency sweep control parameter according to the first embodiment.

FIG. 5 is a diagram illustrating a procedure of calibrating a frequency of light emitted from a wavelength-swept light source according to a second embodiment.

FIG. 6 is a diagram illustrating a procedure of calibrating frequencies of light emitted from a wavelength-swept light source in Example 1.

FIG. 7 is a conceptual diagram illustrating an internal configuration of an operational processing apparatus in Example 1.

FIG. 8 is a diagram illustrating a procedure of calibrating frequencies of light emitted from a wavelength-swept light source in Example 2.

FIG. 9 is a conceptual diagram illustrating a method of measuring a maximum active layer gain of a light source in Example 3.

### DESCRIPTION OF EMBODIMENTS

### First Embodiment

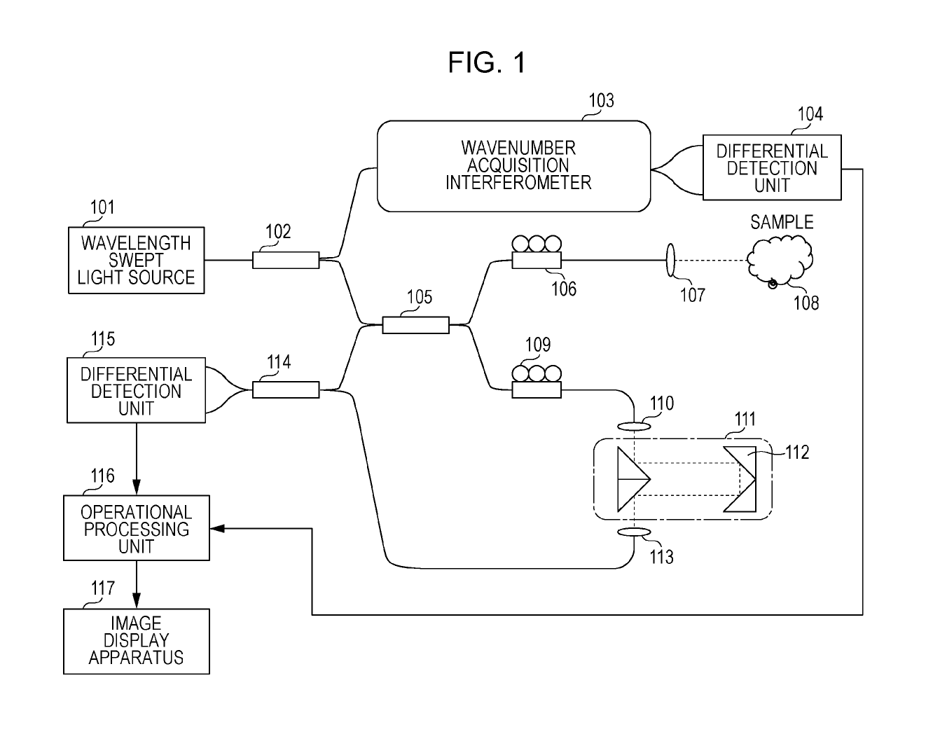

An example of an optical frequency calibration method for a wavelength-swept light source of an optical coherence tomography apparatus (OCT apparatus) according to a first embodiment is described below. The following description of the first embodiment focuses on the method of calibrating an optical frequency of light emitted from a wavelength-swept light source based on information acquired from a wavenumber acquisition interferometer thereby allowing it to compensate for an initial error of a wavelength and a sweeping range of the wavelength-swept light source or a change in the wavelength and the sweeping range occurring with time. FIG. 1 is a conceptual diagram illustrating an overall configuration of an SS-OCT system using the wavelength-swept light source according to the present embodiment. A wavelength-swept light source 101 emits light, which travels inside an optical fiber (represented by a solid line) and is incident on a photo coupler 102. The light is split by the photo coupler 102 into two parts of light, one of which is incident as measurement light to an OCT measurement system, and the other is incident on a wavenumber acquisition interferometer 103.

The measurement light incident on the measurement system is incident on a photo coupler 105 and is split thereby into subject measurement light and reference light. The subject measurement light passes through a polarization controller 106 and strikes a subject (an object to be examined) 108 via a fiber coupling lens 107. In FIG. 1, a broken line following the fiber coupling lens 107 is drawn to represent that the light travels through space. Reflected light (signal light) from the subject 108 is again incident on the coupling lens 107 and thus it returns to the fiber system and travels backward along the same path as the forward path. That is, the signal light is split by the photo coupler 105 into two parts of light, and one of them is incident on the fiber coupler 114, while the other one passes through the photo coupler 102 and returns to the light source. Note that most of the returning light is absorbed by an optical isolator (not illustrated) without reaching the light source.

On the other hand, the reference light passes through a polarization controller 109 and comes into a space system via a fiber coupling lens 110. In the space system, the reference light is incident on a reference mirror unit 111. The reference mirror unit 111 includes four 45° cube mirrors 112 thereby allowing it to adjust an optical path length. After passing though the reference mirror unit 111, the reference light returns to a fiber system via a fiber coupling lens 113 and is incident on a fiber coupler 114. At the fiber coupler 114, the signal light and the reference light returned from the reference mirror are combined together into combined light. The combined light creates an interference signal, which is detected by a differential detection unit 115 and converted into an electric signal. The electric signal is sent to an operational processing apparatus 116 including an electric circuit, a computer, or the like.

The light originating from the light source and incident on the wavenumber acquisition interferometer 103 is output as wavenumber acquisition interference light from the wavenumber acquisition interferometer 103 and is then detected and converted into an electric signal by a differential detection unit 104. This resultant electric signal is sent to the operational processing apparatus 116. Specific examples of wavenumber acquisition interferometers usable for the above purpose include a Michelson interferometer, a Mach-Zehnder interferometer, and other known types of interferometers.

Specific examples of light sources usable as the wavelength-swept light source 101 in the OCT system include a wavelength-swept laser using a wavelength-swept filter (driven by a polygon mirror, a galvanomirror, or the like), an FDML laser, a MEMS wavelength-swept light source (such as MEMS VCSEL, an external cavity MEMS Fabry-Perot laser, etc.), an SGDBR laser, etc. Note that the number of light sources is not limited to one, but a plurality of light sources may be provided. In the OCT system, the operational processing apparatus 116 may be realized by one of or a combination of an analog or digital electrical or electronic circuits, a computer, etc.

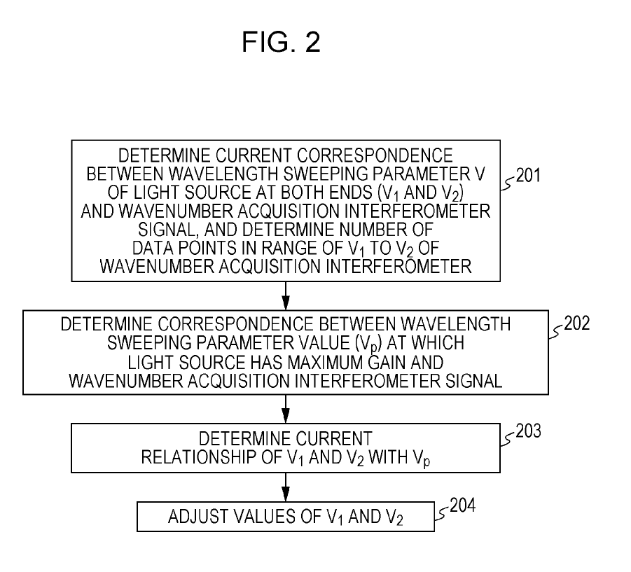

Next, a description is given below as to a method of calculating a frequency of light emitted from a wavelength-swept light source according to the present embodiment. In the following description, by way of example, the calibration of the frequency of light emitted from the wavelength-swept light source is performed for an OCT measurement system such as that described above. FIG. 2 is a diagram illustrating a procedure of calibrating a frequency of light emitted from a wavelength-swept light source according to the present embodiment. In the present embodiment, the procedure of the calibration method includes four main steps described below. Note that the wavelength, the wavenumber, and the frequency can be converted among each other to an equivalent value. In the following description, for convenience, the frequency (proportional to the wavenumber) is used in any description of measurement data or the like acquired by the wavenumber acquisition interferometer, except for three terms, i.e., the wavelength-swept light source, the wavenumber acquisition interferometer, and a wavenumber data point, which will be defined later.

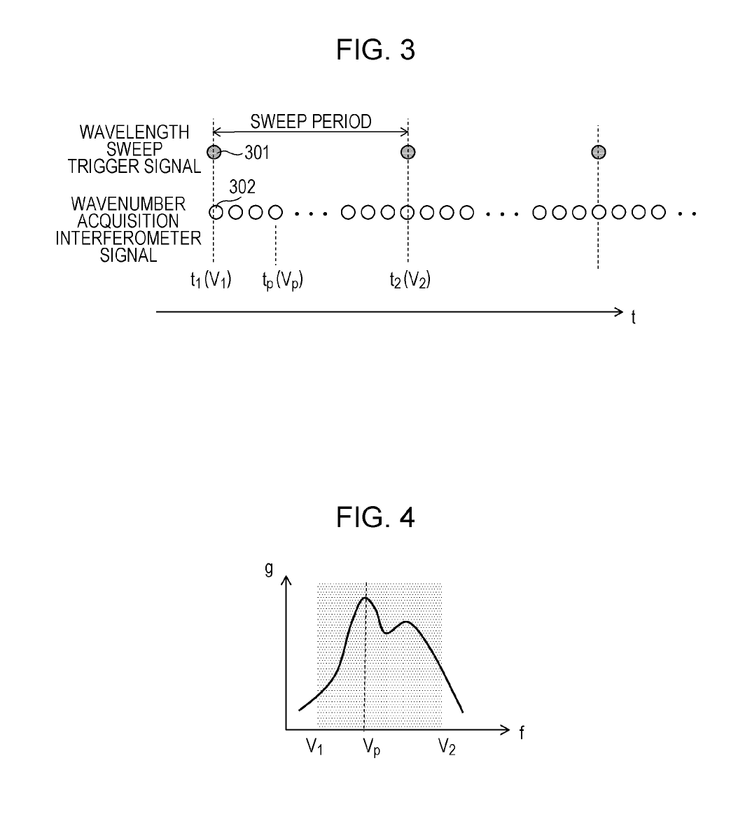

In a first step denoted by 201 in FIG. 2, a determination is performed as to a correspondence between frequencies of a wavenumber acquisition interference signal and those values of a control parameter V of an optical frequency sweeping mechanism of the wavelength-swept light source that are at a higher-frequency end and a lower-frequency end of a frequency sweeping range (hereinafter, the values of V at the higher-frequency end and the lower-frequency end will be respectively referred to as V₁ and V₂ (V₁>V₂)). FIG. 3 is a diagram schematically illustrating a concept of information (data) output from the wavenumber acquisition interferometer. The data output from the wavenumber acquisition interferometer is given in the form of time series data as illustrated in FIG. 3. In FIG. 3, circles indicate data points at equal frequency intervals. Reference numeral 301 denotes a data point corresponding to a trigger signal that causes frequency sweeping to start, and reference numeral 302 denotes a data point (wavenumber data point) corresponding to a wavenumber acquisition interferometer signal. Data points at times t₁ and t₂ of respective ends of a frequency sweep period correspond to V₁ and V₂, and thus, based on this fact, the above-described correspondence may be determined. A determination is then performed as to the number of data points of the wavenumber acquisition interference signal occurring between t₁ (V₁) and t₂ (V₂) (step 201). The number of data points corresponds to a frequency sweep bandwidth of the light source. Note that although signal points are denoted by circles in FIG. 3, an actual signal generally has a shape of a rectangular pulse or the like as with a clock signal. Each signal points correspond to the particular parts of the clock signal, such as rising points of the rectangular pulse.

In a second step denoted by 202 in FIG. 2, a value Vₚ of V is determined at which the gain of an active layer (active medium) of the light source has a maximum value. As illustrated in FIG. 4, as the frequency is swept by changing V, the gain g changes, which has a maximum value (or a greatest value) at a certain value Vₚ of V. In FIG. 4, a shaded area indicates a frequency sweeping range. In a case where a laser light source is used as the light source, one method of determining Vₚ is to measure a threshold value of the laser while changing V and determine a value of V as Vₚ at which the threshold current density has a minimum value. An example of a method of measuring the threshold value may be as follows. While changing a mirror driving voltage (that is, a mirror position) corresponding to the voltage wavenumber data point, a set of data is acquired in terms of a current vs. light output (IL) characteristic or an excitation light vs. light output (LL) characteristic of the laser. It may be preferable to make measurement at as many data points as possible. However, when measurement for such many data points results in a problem such as a reduction in calibration speed or the like, the measurement of the threshold value may be performed at every two or more data points. The optical output for determining the threshold value may be measured by one of various methods. For example, in a method, light emitted from a laser is partially extracted and detected by a detector. In a case where a Fabry-Perot cavity laser is used, light emitted from a side opposite to the signal side of the laser may be measured. In another method, a leakage light component leaking out from a cavity may be measured. In another method, the light output from wavenumber acquisition interferometer may be measured.

In a third step denoted by 203 in FIG. 2, the relationship is determined between the wavenumber data point corresponding to the Vₚ at the maximum of the gain and the wavenumber data points corresponding to the frequency sweep band V₁ to V₂ of the light source, and the obtained relationship is evaluated. In a fourth step denoted by 204 in FIG. 2, in a case where the evaluation indicates that the current relationship is not proper, the parameter values V₁ and V₂ are adjusted so as to obtain a proper relationship. More specifically, for example, the driving voltage range ΔV(=V₁−V₂) is first adjusted such that the number of wavenumber data points becomes proper, and then the values V₁ and V₂ are changed while maintaining the number of wavenumber data points. In this process, when the value of V is changed, a corresponding change occurs in the frequency. Therefore, it may be necessary to refine the driving voltage range ΔV.

Even when the relationship between the parameter V of the wavelength-swept light source and the maximum of the gain deviates from a proper relationship due to an initially-existing or occurring-with-time error, it is possible to adjust the relationship to the proper one by performing the process from the first step (201) to the fourth step (204). In performing the calibration of the frequency of the light of the wavelength-swept light source, it may be preferable to perform the calibration using the measurement apparatus used in the OCT measurement other than the control system. It may be more preferable to perform the calibration using the default measurement apparatus used in the OCT measurement including the control system. More specifically, for example, it may be particularly preferable to perform the calibration using the frequency sweep calibration unit disposed in the operational processing unit of the OCT apparatus based on information acquired by the wavenumber acquisition interferometer disposed in the OCT apparatus.

In the method of calibrating the frequency of the light of the wavelength-swept light source, for example, in a case where the wavelength-swept light source is a semiconductor laser using a MEMS mirror, the frequency control parameter V is a driving voltage of the MEMS mirror. In the method of calibrating the frequency of the light of the wavelength-swept light source, the process from steps 201 to 204 may be performed once for the calibration. Or the process may be performed repeatedly a plurality of times such that the adjusted voltages are again evaluated with reference to proper values and readjusted so as to further reduce errors. In the second step (202) described above, the number of maximums of the gain is not limited to one but there may be a plurality of maximums in the frequency sweep band. In the above-described method of calibrating the frequency of the light of the wavelength-swept light source, each step thereof may be executed by a computer. In this case, a computer program for the above-described purpose may be stored in a computer-readable storage medium disposed in a data storage mechanism of the computer in the operational processing apparatus.

### Second Embodiment

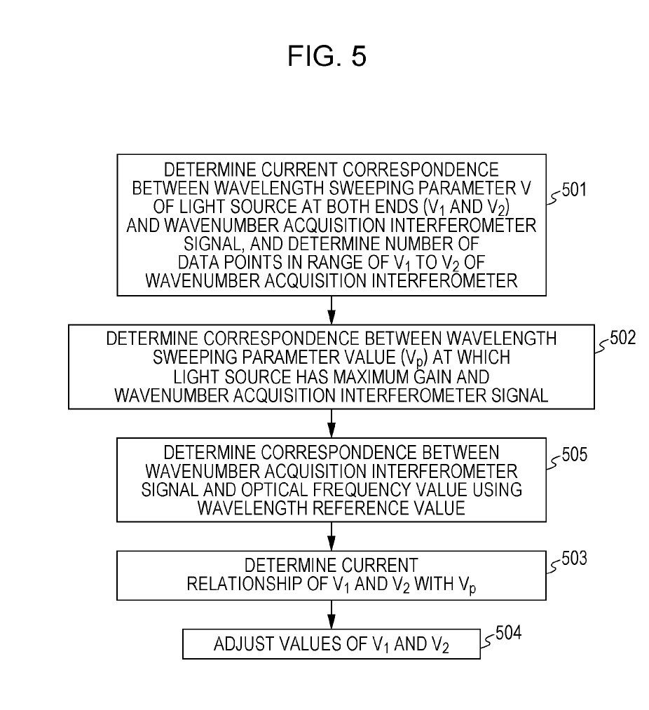

A second embodiment described below discloses a method of making a calibration in a different manner from the first embodiment described above. The OCT apparatus used is similar in configuration to that according to the first embodiment, and thus a duplicated description thereof is omitted. Referring to FIG. 5, a procedure of calibrating frequencies of light emitted from a wavelength-swept light source according to the present embodiment is described below. In the present embodiment, after a step (502) in FIG. 5, corresponding to the second step (202) according to the first embodiment, an additional step 505 is inserted. In this step 505, a determination is performed as to a correspondence between the wavenumber measurement interference signal (the signal of the wavenumber acquisition interferometer) and the optical frequency value using a predetermined reference optical frequency value, that is, the optical frequency value of each data point of the wavenumber acquisition interferometer is determined. The data of the wavenumber acquisition interferometer is output at equal intervals of frequency in any frequency range. Therefore, if a reference frequency value at a certain point is given, then it is possible to calculate frequencies for all data points. As for the reference frequency value, for example, a frequency value corresponding to a maximum gain may be used. In this case, an initial value of the light source may be used.

By adding the step 505 described above, it becomes possible to identify frequency values not only for those corresponding to V₁, V₂, and Vₚ but for all data points, and thus it becomes possible to define the sweep frequency band by frequency values instead of wavenumber data points. Thus, it becomes possible to evaluate a mutual correspondence among V₁, V₂, and Vₚ based on their frequencies, and it becomes possible to adjust the sweeping range based on the actual frequency values. In a case where a plurality of light sources are used, use of the actual frequency values makes it possible to identify the sweeping band covered by each light source and easily adjust each sweeping band such that there is no overlap between them.

### EXAMPLE

Next, examples of the present invention are described below.

### Example 1

An optical frequency calibration method for a wavelength-swept light source and an example of a configuration of an OCT apparatus according to Example 1 are described below. In the OCT apparatus according to the example, a common-type OCT system illustrated in FIG. 1 is used. As for a light source, a VCSEL (MEMS VCSEL) using a MEMS movable mirror is used. The MEMS VCSEL operates such that when a voltage is applied between electrodes of the MEMS movable mirror, the mirror is attracted by an electrostatic attractive force to the VCSEL. As a result, the cavity length determined by the mirror position is changed, and thus it is possible to sweep the frequency. In the present example, the sweep frequency band is from 1030 nm to 1090 nm. During the measurement process, the mirror is usually driven by a sinusoidal wave at a sweep frequency of 200 kHz. As for the MEMS VCSEL, a GaAs-based compound semiconductor laser including an InGaAs active layer is used. In the present example, a semiconductor optical amplifier (SOA) for optical output amplification is disposed at a stage following the MEMS VCSEL such that a combination of the light source and the SOA functions as a single light source. The photo couplers 102, 105, and 114 are set to have branching ratios of 95:5 (95 to the OCT measurement system), 90:10 (90 to the subject), and 50:50, respectively. A Mach-Zehnder interferometer is used as the wavenumber acquisition interferometer. The A/D converter is set to operate at a clock frequency of 400 MHz.

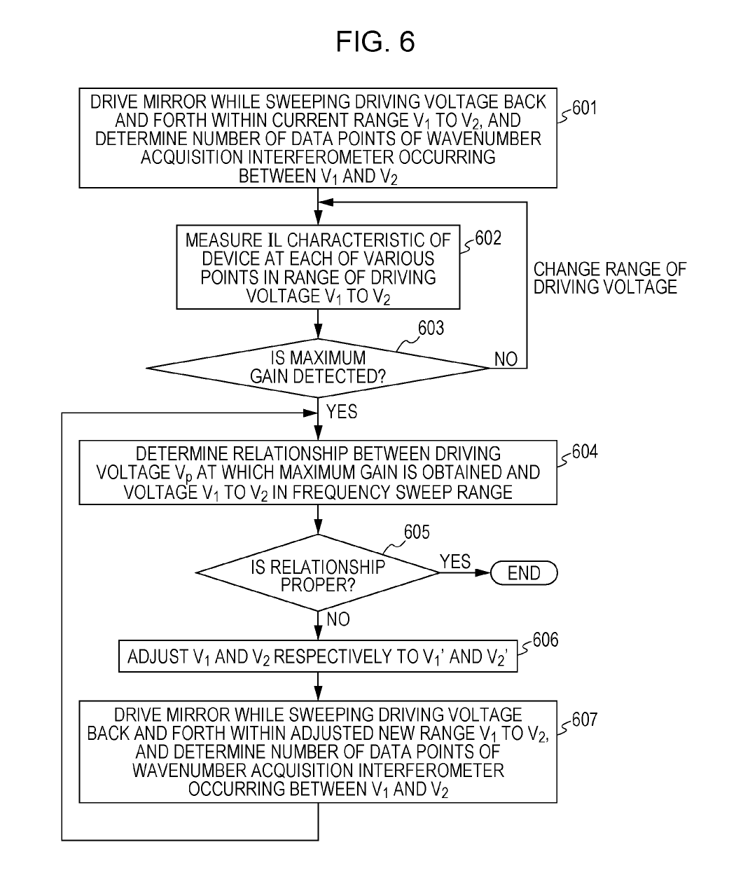

Referring to FIG. 6, a procedure of calibrating the frequency of light emitted from the wavelength-swept light source according to the present example is described below. First, the mirror is swept back and forth by changing the driving voltage applied thereto within a current driving voltage range from V₁ (maximum) to V₂ (minimum) and a determination of the number of data points of the wavenumber acquisition interferometer occurring during the voltage range is performed each sweep period (601). In the present example, V₁=55 V and V₂=5 V. The determination of the number of data points may be performed as described above in the embodiments. In the present example, the number of data points of the wavenumber acquisition interferometer is set to 512 per sweep. There is a possibility that no wavenumber data point occurs at an exact driving voltage of V₁ or V₂. In this case, a data point occurring at a driving voltage closest to V₁ or V₂ is employed. Next, the driving voltage is changed stepwise from point to point in the range from V₁ to V₂, and the IL characteristic of the VCSEL device is measured at each point (602). In the present example, the measurement is performed with a voltage corresponding to each of all wavenumber data points. The obtained measurement data is stored in a memory in a computer in the operational processing apparatus. In the operational processing apparatus, as described above in the embodiment, a minimum threshold value at a maximum gain value is detected. In a case where a maximum gain value is obtained during the sweep from V₁ to V₂, the processing flow proceeds to a next step. However, a maximum gain value is not obtained, the driving voltage range from V₁ to V₂ is changed, and a maximum gain value is again sought (603). After a driving voltage Vₚ corresponding to the maximum gain value is detected, the operational processing apparatus compares V₁, V₂, and Vₚ with the data of the wavenumber acquisition interferometer to evaluate the current relationship between them (604). A determination is then performed as to whether the obtained relationship is proper with reference to the relationship of V₁ and V₂ to Vₚ that are regarded in advance as being proper and that have been prestored in the operational processing apparatus. In a case where no wavenumber data point is obtained at an exact voltage V₁ or V₂ or Vₚ, a data point occurring at a voltage closest to V₁ or V₂ or Vₚ is employed. If the wavenumber data points corresponding to V₁, V₂, and Vₚ agree with proper data within a predetermined allowable error, then the relationship is determined to be proper and the calibration process is ended, but otherwise it is determined that the relationship is not proper and thus the voltage adjustment is to be performed (605). The allowable error depends on the number of data points within the sweep frequency range, but in general it may be preferable within 1% of the total number. In the present example, 1% of the total number of 512 points is 5 points, and thus the error may be preferable within 5 points. In a case where the wavenumber data points are not proper, the voltage adjust is performed in a similar manner as described in the embodiments. That is, V₁ and V₂ of the mirror driving voltage are respectively set to new different values V₁′ and V₂′ considering the number of wavenumber data points and the relationship of V1, V₂, to Vₚ (606). After the voltages are set to new values, step 607 is performed in a similar manner to step 601 except that the new voltage range from V₁=V₁′ to V₂=V₂′. Thereafter, the processing flow returns to step 604 to evaluate the relationship for new values V₁=V₁′ and V₂=V₂′, and Vₚ. The loop is executed repeatedly until the proper relationship is achieved.

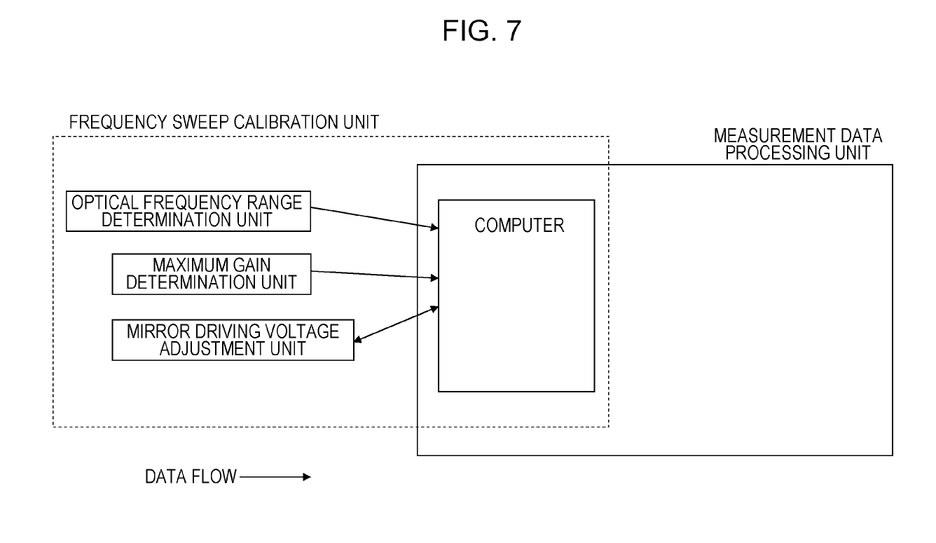

FIG. 7 illustrates an internal configuration of the operational processing apparatus according to the present example. In the calibration process according to the present example, signals and data are processed by a frequency sweep calibration unit in the operational processing apparatus, and other measurement data is processed by a measurement data processing unit. Note that only a computer is shared by both the frequency sweep calibration unit and the measurement data processing unit. In the present example, a data storage mechanism is provided by a storage medium in the computer. A user is allowed to select either a measurement operation mode or a calibration operation mode by operating a switch thereby selecting corresponding mechanisms in the operational processing apparatus. A computer program to be executed to perform the calibration procedure is also stored in a storage medium in the computer.

In the present example, the frequency sweep calibration unit includes, in addition to the computer, an optical frequency range determination unit, a maximum-of-gain determination unit, and a mirror driving voltage adjustment unit. Step 601 illustrated in FIG. 6 is performed by the optical frequency range determination unit such that signals are acquired while driving the mirror in the range V₁ to V₂ a plurality of times, an interference signal is converted into a binary form (for example, using a rectangular wave), an A/D conversion process and other processes are performed, and resultant data is sent to the computer. The optical frequency range determination unit includes a zero crossing detector, a logic circuit, an A/D converter, etc. The computer counts the number of wavenumber data points in each mirror driving period, and performs the counting for a plurality of mirror driving periods. Step 602 is performed by the maximum-of-gain determination unit. The maximum-of-gain determination unit includes a circuit configured to convert data of the measured IL characteristic into a digital signal. The resultant IL data is sent to the computer. In step 603, the computer detects a value of V at which a minimum threshold value is obtained and selects wavenumber data points. In a case where a minimum threshold value is not detected in the range from V₁ to V₂ in step 603, the voltage range is changed via the mirror driving voltage adjustment unit. The mirror driving voltage adjustment unit may be an adjustment mechanism disposed in the mirror driving power supply or may be provided separately from the mirror driving power supply. Steps 604 and 605 are performed inside the computer. Step 606 is performed by the mirror driving voltage adjustment unit. First, the driving voltage range is adjusted to a new value ΔV′=V₁′−V₂′ such that the number of wavenumber data points is adjusted to a proper value, and then the voltages are shifted to proper values over whole driving voltage range. Step 607 is then performed in a similar manner to step 601 and resultant data is supplied to the computer, which performs steps 604 and 605. The above process is performed repeatedly until it is determined finally in step 605 that proper values are obtained for Vₚ and V₁′ and V₂′.

In the present example, the frequency sweep calibration unit includes not only the computer but also includes additional parts (such as the optical frequency range determination unit, etc.) for performing some steps in the calibration operation. Alternatively, the whole process may be performed by the computer. In this case, the process performed by the above-described parts may be performed by the measurement data processing unit, which makes it possible to perform the calibration process using only the apparatus associated with the OCT measurement, and thus it becomes possible to simplify the system.

### Example 2

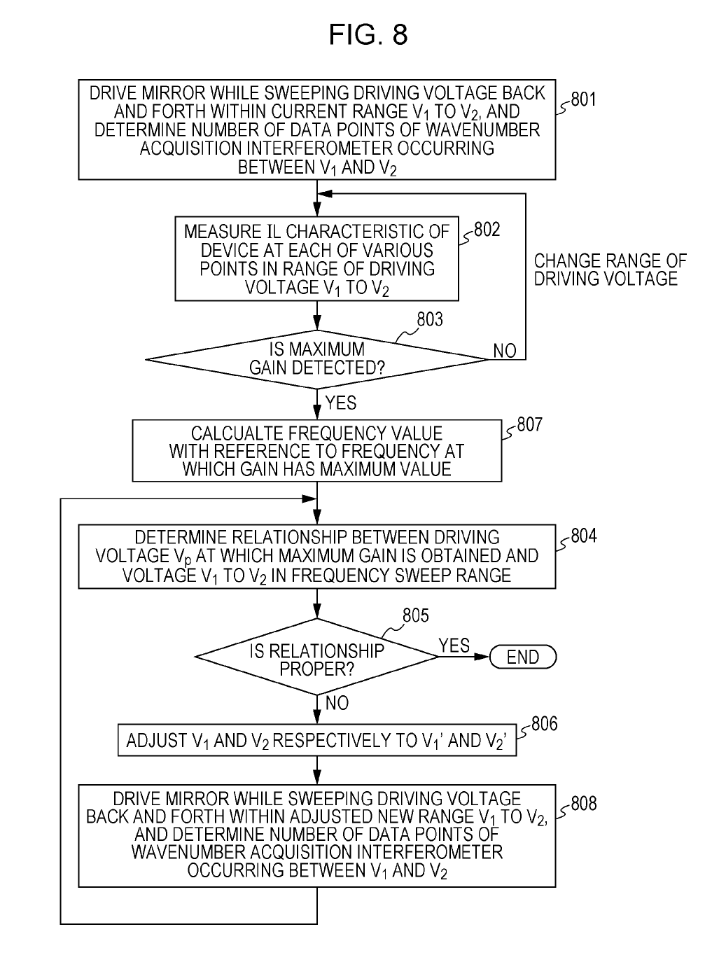

An optical frequency calibration method for a wavelength-swept light source according to an Example 2 different from the Example 1 is described below. In the present example, the OCT system and the measurement system used are similar to those used in the Example 1 described above. Note that the following description focuses on differences from the Example 1. Referring to FIG. 8, a procedure of calibrating the frequency of light emitted from a wavelength-swept light source according to the present example is described below. The procedure according to the present example includes an additional step (807) in addition to those according to the Example 1. In this additional step (807), frequency values are determined with reference to a frequency at which a maximum gain value is obtained, and this step is performed between a step (803) of determining the maximum of the gain and a step (804) of determining a relationship between Vₚ and V₁ and V₂. The method is similar to that described above in the second embodiment. When a reference frequency is given, then it is possible to determine frequency values for all wavenumber data points by performing a simple calculation. In the present example, the operational processing apparatus is configured in a similar manner to that according to the Example 1, and step 807 is performed in the computer following step 803. By employing the present example for the calibration process, it becomes possible to deal with the sweep range of the light source using frequency values.

### Example 3

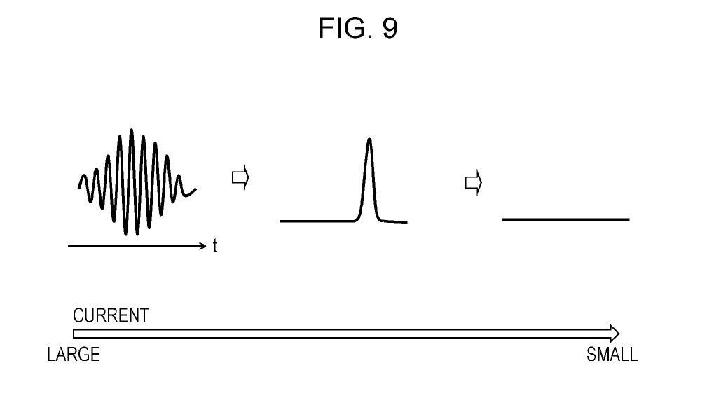

Example 3 described below is different from Example 1 in that in determining the maximum of the gain in step 602 in FIG. 6, the threshold value is measured by a method different from that used in the Example 1. The following description of Example 3 focuses on the difference from the Example 1. Referring to FIG. 9, a method of measuring a maximum of an active layer gain of a light source according to the Example 3 is described below. In FIG. 9, each waveform represents a light waveform before being converted into digital form. FIG. 9 schematically illustrates a manner in which the signal waveform changes as a driving current of the light source is reduced. As may be seen from FIG. 9, in a state in which oscillation is occurring when being driven by a high current, a normal interference waveform is obtained. However, when the current is reduced, oscillation stops in a frequency band in which the gain is low. Finally, no oscillation occurs in any frequency band, and thus the signal level drops down to a noise level. In the wavenumber acquisition interferometer, interference occurs due to an optical path length difference of about a few mm. Therefore, in a state in which no laser oscillation occurs, interference is weak and no interference signal is output from the differential detection unit. Therefore, when the driving current of the light source is reduced to a critical level at which oscillation is allowed only at a particular frequency and below which no oscillation is allowed, an interference signal is obtained for a lowest driving current at a particular frequency. In this frequency, the threshold value is at the minimum value. By determining the frequency in this state, it is possible to determine the minimum threshold value, that is, the mirror driving voltage Vₚ corresponding to the maximum of the gain. The driving current for obtaining the interference signal may be most preferably a minimum value thereof, and secondly preferably a value within a range from the minimum value to a +5% greater than the minimum value.

Vₚ may be determined, for example, as follows. First, the minimum oscillation current is detected. Then the current is maintained at the detected minimum oscillation current, and the mirror driving voltage is gradually changed until a signal is obtained. Vₚ is given by the value of the mirror driving voltage in this state. In this case, the signal can be obtained with a detector used to determine the IL characteristic of the laser according to the first embodiment. Instead of detecting signals over the whole mirror driving voltage range, the mirror may be swept back and forth and Vₚ may be first roughly estimated by calculating with a temporal location of a trigger signal and then the mirror driving voltage may be swept more finely around the vicinity of the roughly estimated value Vₚ. Alternatively, Vₚ may be determined only by estimating the temporal location of the trigger signal. In the estimation of the time at which Vₚ appears from the trigger signal, it is not allowed to use the method of counting the number of wavenumber data points because no signal from the wavenumber acquisition interferometer is obtained. Instead, for example, a reference clock signal from the A/D converter may be used.

In the present example, the step of detecting the maximum of the gain and the step of determining Vₚ based on corresponding wavenumber data are performed inside the computer. In the method according to the present example, in contrast to the method according to the first example in which the measurement of the IL characteristic is performed for each wavenumber data point, the measurement is performed using the wavenumber acquisition interferometer while dynamically moving the mirror and thus it is possible to reduce the measurement time. In the example described above, the light source driving current is gradually reduced in detecting the maximum of the gain of the light source. Conversely, the light source driving current may be gradually increased.

### Other Embodiments

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-092112, filed Apr. 25, 2013 which is hereby incorporated by reference herein in its entirety.

### REFERENCE SIGNS LIST

101 wavelength-swept light source
102 photo coupler
103 wavenumber acquisition interferometer
104 differential detection unit
105 photo coupler
106 polarization controller
107 fiber coupling lens
108 subject
109 polarization controller
110 fiber coupling lens
111 reference mirror unit
112 45° cube mirror
113 fiber coupling lens
114 fiber coupler
115 differential detection unit
116 operational processing apparatus
117 image display apparatus

1. A method of calibrating an optical frequency of light emitted from a wavelength-swept light source based on information acquired from a wavenumber acquisition interferometer thereby allowing it to compensate for an error of the wavelength of the wavelength-swept light source, the method comprising:
performing a first process of measuring an optical frequency range of the emitted light by the wavenumber acquisition interferometer while changing a control parameter associated with an optical frequency sweeping mechanism included in the wavelength-swept light source, and determining a correspondence between the control parameter and the optical frequency range;
performing a second process of measuring a maximum of a gain of an active medium included in the wavelength-swept light source and determining a correspondence between the maximum of the gain and the control parameter;
performing a third process of determining a relationship between the optical frequency range of the emitted light and the control parameter corresponding to the maximum gain of the active medium; and
performing a fourth process of adjusting the control parameter based on a result of the determination as to the relationship.

2. The method according to claim 1, wherein
the wavenumber acquisition interferometer is a wavenumber acquisition interferometer disposed in an optical coherence tomography apparatus; and
the determinations in the first through third processes are performed using information acquired from the wavenumber acquisition interferometer disposed in the optical coherence tomography apparatus.

3. The method according to claim 1, wherein the measuring the maximum gain is performed by determining a value of the control parameter that allows an interference signal to be obtained under a condition that a driving current of the light source is set to the smallest value that allows an interference signal to be obtained.

4. The method according to claim 3, wherein the determining the value of the control parameter corresponding to the value that allow an interference signal to be obtained under the condition that the driving current of the light source is set to the smallest value that allows an interference signal to be obtained is performed by making a determination, using information of a temporal location of the obtained interference signal of the wavenumber acquisition interferometer, as to a correspondence between the control parameter and the interference signal.

5. The method according to claim 1, further comprising performing, between the second and third processing, a process of determining a correspondence between the control parameter and an optical frequency value of the wavelength-swept light source,
wherein the determining the correspondence between the control parameter and the optical frequency value of the wavelength-swept light source is performed using a reference frequency value.

6. The method according to claim 5, wherein the reference frequency value used in determining the correspondence between the control parameter of the optical frequency sweeping mechanism and the optical frequency is a frequency value corresponding to the maximum of the gain of the active medium.

7. The method according to claim 5, wherein
the wavenumber acquisition interferometer is a wavenumber acquisition interferometer disposed in an optical coherence tomography apparatus; and
the determination as to the correspondence between the control parameter and the optical frequency value of the wavelength-swept light source is performed using information acquired from the wavenumber acquisition interferometer disposed in the optical coherence tomography apparatus.

8. The method according to claim 1, wherein
the wavelength-swept light source is a wavelength-swept light source including an optical frequency sweeping mechanism using a micro electronic mechanical system (MEMS), and
the control parameter is a driving voltage of the MEMS.

9. A program configured to control a computer to execute the method of calibrating the optical frequency of light emitted from the wavelength-swept light source according to claim 1.

10. A computer-readable storage medium storing the program according to claim 9.

11. An apparatus including a wavenumber acquisition interferometer and a frequency sweep calibration unit and configured to calibrate an optical frequency of light emitted from a wavelength-swept light source based on information acquired from the wavenumber acquisition interferometer thereby allowing it to compensate for an error of a wavelength of the wavelength-swept light source,
the frequency sweep calibration unit comprising:
an optical frequency range determination unit configured to measure an optical frequency range of the light emitted from the wavenumber acquisition interferometer and determine a correspondence between a control parameter of an optical frequency sweeping mechanism included in the wavelength-swept light source and the optical frequency range;
a maximum-of-gain determination unit configured to determine a correspondence between a maximum of a gain of an active medium included in the wavelength-swept light source and a value of the control parameter; and
an adjustment unit configured to determine a relationship between values of the control parameter corresponding to the optical frequency range and a value of the control parameter corresponding to the maximum gain, evaluate a deviation of a value from a proper value of the control parameter, and adjust the values of the control parameter based on the evaluated deviation.

12. The apparatus according to claim 11, wherein the maximum-of-gain determination unit determines the correspondence between the maximum gain and the value of the control parameter by determining a value of the control parameter that allows an interference signal to be obtained under a condition that a driving current of the light source is set to the smallest value that allows an interference signal to be obtained.

13. The apparatus according to claim 12, wherein the determining the value of the control parameter corresponding to the value that allow an interference signal to be obtained under the condition that the driving current of the light source is set to the smallest value that allows an interference signal to be obtained is performed by making a determination, using information of a temporal location of the obtained interference signal of the wavenumber acquisition interferometer, as to a correspondence between the maximum gain and the control parameter.

14. The apparatus according to claim 11, wherein
the wavelength-swept light source is a wavelength-swept light source including an optical frequency sweeping mechanism using a micro electronic mechanical system, and
the control parameter is a driving voltage of the micro electronic mechanical system.

15. An optical coherence tomography apparatus configured to perform a tomographic measurement on a subject by performing, using an operational processing unit, an operational process on the interference data between the light returned from the subject illuminated with measurement light and reference light,
wherein the wavenumber acquisition interferometer in the optical frequency calibration apparatus according to claim 11 is disposed in the optical coherence tomography apparatus.

16. An optical coherence tomography apparatus configured to perform a tomographic measurement on a subject by performing, using an operational processing unit, an operational process on the interference data between light returned from the subject illuminated with measurement light and reference light,
wherein the frequency sweep calibration unit in the optical frequency calibration apparatus according to claim 11 is disposed in the operational processing unit.

17. A method of calibrating an optical frequency of light emitted from a wavelength-swept light source based on information acquired from a wavenumber acquisition interferometer, the method comprising:
performing a process of measuring an optical frequency range of the emitted light by the wavenumber acquisition interferometer while changing a control parameter associated with an optical frequency sweeping mechanism included in the wavelength-swept light source, and determining a correspondence between the control parameter and the optical frequency range; and
performing a process of adjusting the control parameter based on a result of the determination as to the relationship.
